(19) United States
(12) Patent Application Publication
(10) Pub. No.: US 2012/0163465 A1
(43) Pub. Date: Jun. 28, 2012

(54) METHOD FOR ENCODING A VIDEO SEQUENCE AND ASSOCIATED ENCODING DEVICE

(75) Inventors: PATRICE ONNO, RENNES (FR); GUILLAUME LAROCHE, RENNES (FR)

(73) Assignee: CANON KABUSHIKI KAISHA, Tokyo (JP)

(21) Appl. No.: 13/331,800

(22) Filed: Dec. 20, 2011

(30) Foreign Application Priority Data
Dec. 22, 2010 (GB) 1021768.5

(51) Int. Cl. H04N 7/26

(52) U.S. Cl. 375/240.16; 375/E07.125

(57) ABSTRACT

The invention concerns a method for encoding a video sequence comprising generating first and second reconstructions of the same first image using different reconstruction offsets when inverse quantizing transformed blocks, these two reconstructions being possible reference images for encoding another image in the sequence, wherein generating the second reconstruction comprises selecting a subset from the possible reconstruction offsets; generating image reconstructions of the first image using each offset of the subset; determining, as a first optimum offset θ_{DC}, the reconstruction offset that minimizes a distortion of the image reconstructions; generating an image reconstruction of the first image using the opposite value −θ_{DC} to the first optimum offset; selecting, between θ_{DC} and −θ_{DC}, the reconstruction offset minimizing a distortion of the associated image reconstructions, as the second different reconstruction offset.

This application claims priority from GB patent application No. 10 21768.5 of Dec. 22, 2010 which is incorporated herein by reference.

### FIELD OF THE INVENTION

The present invention concerns a method for encoding a video sequence, and an associated encoding device.

### BACKGROUND OF THE INVENTION

Video compression algorithms, such as those standardized by the standardization organizations ITU, ISO, and SMPTE, exploit the spatial and temporal redundancies of images in order to generate bitstreams of data of smaller size than original video sequences. Such compressions make the transmission and/or the storage of video sequences more efficient.

FIGS. 1 and 2 respectively represent the scheme for a conventional video encoder 10 and the scheme for a conventional video decoder 20 in accordance with the video compression standard H.264/MPEG-4 AVC (“Advanced Video Coding”).

The latter is the result of the collaboration between the “Video Coding Expert Group” (VCEG) of the ITU and the “Moving Picture Experts Group” (MPEG) of the ISO, in particular in the form of a publication “Advanced Video Coding for Generic Audiovisual Services” (March 2005).

FIG. 1 schematically represents a scheme for a video encoder 10 of H.264/AVC type or of one of its predecessors.

The original video sequence 101 is a succession of digital images “images i”. As is known per se, a digital image is represented by one or more matrices of which the coefficients represent pixels.

According to the H.264/AVC standard, the images are cut up into “slices”. A “slice” is a part of the image or the whole image. These slices are divided into macroblocks, generally blocks of size 16 pixels×16 pixels, and each macroblock may in turn be divided into different sizes of data blocks 102, for example 4×4, 4×8, 8×4, 8×8, 8×16, 16×8. The macroblock is the coding unit in the H.264 standard.

During video compression, each block of an image is predicted spatially by an “Intra” predictor 103, or temporally by an “Inter” predictor 105. Each predictor is a set of pixels of the same size as the block to be predicted, not necessarily aligned on the grid decomposing the image into blocks, and is taken from the same image or another image. From this set of pixels (also hereinafter referred to as “predictor” or “predictor block”) and from the block to be predicted, a difference block (or “residue”) is derived. Identification of the predictor block and coding of the residue make it possible to reduce the quantity of information to be actually encoded.

It should be noted that, in certain cases, the predictor block can be chosen in an interpolated version of the reference image in order to reduce the prediction differences and therefore improve the compression in certain cases.

In the “Intra” prediction module 103, the current block is predicted by means of an “Intra” predictor, a block of pixels constructed from information on the current image already encoded.

With regard to “Inter” coding by temporal prediction, a motion estimation 104 between the current block and reference images 116 (past or future) is performed in order to identify, in one of those reference images, the set of pixels closest to the current block to be used as a predictor of that current block. The reference images used consist of images in the video sequence that have already been coded and then reconstructed (by decoding).

Generally, the motion estimation 104 is a “Block Matching Algorithm” (BMA).

The predictor block identified by this algorithm is next generated and then subtracted from the current data block to be processed so as to obtain a difference block (block residue). This step is called “motion compensation” 105 in the conventional compression algorithms.

These two types of coding thus supply several texture residues (the difference between the current block and the predictor block) that are compared in a module for selecting the best coding mode 106 for the purpose of determining the one that optimizes a rate/distortion criterion.

If “Intra” coding is selected, information for describing the “Intra” predictor is coded (109) before being inserted into the bit stream 110.

If the module for selecting the best coding mode 106 chooses “Inter” coding, motion information is coded (109) and inserted into the bit stream 110. This motion information is in particular composed of a motion vector (indicating the position of the predictor block in the reference image relative to the position of the block to be predicted) and appropriate information to identify the reference image among the reference images (for example an image index).

The residue selected by the choice module 106 is then transformed (107) in the frequency domain, by means of a discrete cosine transform DCT, and then quantized (108). The coefficients of the quantized transformed residue are next coded by means of entropy or arithmetic coding (109) and then inserted into the compressed bit stream 110 as part of the useful data coding the blocks of the image.

In the remainder of the document, reference will mainly be made to entropy coding. However, a person skilled in the art is capable of replacing it with arithmetic coding or any other suitable coding.

In order to calculate the “Intra” predictors or to make the motion estimation for the “Inter” predictors, the encoder performs decoding of the blocks already encoded by means of a so-called “decoding” loop (111, 112, 113, 114, 115, 116) in order to obtain reference images for the future motion estimations. This decoding loop makes it possible to reconstruct the blocks and images from quantized transformed residues.

It ensures that the coder and decoder use the same reference images.

Thus the quantized transformed residue is dequantized (111) by application of a quantization operation which is inverse to the one provided at step 108, and is then reconstructed (112) by application of the transformation that is the inverse of the one at step 107.

If the quantized transformed residue comes from an “Intra” coding 103, the “Intra” predictor used is added to that residue (113) in order to obtain a reconstructed block corresponding to the original block modified by the losses resulting from the quantization operation.

If on the other hand the quantized transformed residue comes from an “Inter” coding 105, the block pointed to by the current motion vector (this block belongs to the reference image 116 referred to in the coded motion information) is added to this decoded residue (114). In this way the original block is obtained, modified by the losses resulting from the quantization operations.

In order to attenuate, within the same image, the block effects created by strong quantization of the obtained residues, the encoder includes a “deblocking” filter 115, the objective of which is to eliminate these block effects, in particular the artificial high frequencies introduced at the boundaries between blocks. The deblocking filter 115 smoothes the borders between the blocks in order to visually attenuate these high frequencies created by the coding. As such a filter is known from the art, it will not be described in further detail here.

The filter 115 is thus applied to an image when all the blocks of pixels of that image have been decoded.

The filtered images, also referred to as reconstructed images, are then stored as reference images 116 in order to allow subsequent “Inter” predictions to take place during the compression of the following images in the current video sequence.

The term “conventional” will be used below to refer to the information resulting from this decoding loop used in the prior art, that is to say in particular that the inverse quantization and inverse transformation are performed with conventional parameters. Thus reference will now be made to “conventional reconstructed image” or “conventional reconstruction”.

In the context of the H.264 standard, a multiple reference option is provided for using several reference images 116 for the estimation and motion compensation of the current image, with a maximum of 32 reference images taken from the conventional reconstructed images.

In other words, the motion estimation is performed on N images. Thus the best “Inter” predictor of the current block, for the motion compensation, is selected in one of the multiple reference images. Consequently two adjoining blocks can have respective predictor blocks that come from different reference images. This is in particular the reason why, in the useful data of the compressed bit stream and for each block of the coded image (in fact the corresponding residue), the index of the reference image (in addition to the motion vector) used for the predictor block is indicated.

FIG. 3 illustrates this motion compensation by means of a plurality of reference images. In this Figure, the image 301 represents the current image during coding corresponding to the image i of the video sequence.

The images 302 and 307 correspond to the images i−1 to i−n that were previously encoded and then decoded (that is to say reconstructed) from the compressed video sequence 110.

In the example illustrated, three reference images 302, 303 and 304 are used in the Inter prediction of blocks of the image 301. To make the graphical representation legible, only a few blocks of the current image 301 have been shown, and no Intra prediction is illustrated here.

In particular, for the block 308, an Inter predictor 311 belonging to the reference image 303 is selected. The blocks 309 and 310 are respectively predicted by the blocks 312 of the reference image 302 and 313 of the reference image 304. For each of these blocks, a motion vector (314, 315, 316) is coded and provided with the index of the reference image (302, 303, 304).

The use of the multiple reference images—the recommendation of the aforementioned VCEG group recommending limiting the number of reference images to four should however be noted—is both a tool for providing error resilience and a tool for improving the efficacy of compression.

This is because, with an adapted selection of the reference images for each of the blocks of a current image, it is possible to limit the effect of the loss of a reference image or part of a reference image.

Likewise, if the selection of the best reference image is estimated block by block with a minimum rate-distortion criterion, this use of several reference images makes it possible to obtain significantly higher compression compared with the use of a single reference image.

FIG. 2 shows a general scheme of a video decoder 20 of the H.264/AVC type. The decoder 20 receives as an input a bit stream 201 corresponding to a video sequence 101 compressed by an encoder of the H.264/AVC type, such as the one in FIG. 1.

During the decoding process, the bit stream 201 is first of all entropy decoded (202), which makes it possible to process each coded residue.

The residue of the current block is dequantized (203) using the inverse quantization to that provided at 108, and then reconstructed (204) by means of the inverse transformation to that provided at 107.

Decoding of the data in the video sequence is then performed image by image and, within an image, block by block.

The “Inter” or “Infra” coding mode for the current block is extracted from the bit stream 201 and entropy decoded.

If the coding of the current block is of the “Intra” type, the index of the prediction direction is extracted from the bit stream and entropy decoded. The pixels of the decoded adjacent blocks most similar to the current block according to this prediction direction are used for regenerating the “Infra” predictor block.

The residue associated with the current block is recovered from the bit stream 201 and then entropy decoded. Finally, the Intra predictor block recovered is added to the residue thus dequantized and reconstructed in the Intra prediction module (205) in order to obtain the decoded block.

If the coding mode for the current block indicates that this block is of the “Inter” type, then the motion vector, and possibly the identifier of the reference image used, are extracted from the bit stream 201 and decoded (202).

This motion information is used in the motion compensation module 206 in order to determine the “Inter” predictor block contained in the reference images 208 of the decoder 20. In a similar fashion to the encoder, these reference images 208 may be past or future images with respect to the image currently being decoded and are reconstructed from the bit stream (and are therefore decoded beforehand).

The quantized transformed residue associated with the current block is, here also, recovered from the bit stream 201 and then entropy decoded. The Inter predictor block determined is then added to the residue thus dequantized and reconstructed, at the motion compensation module 206, in order to obtain the decoded block.

Naturally the reference images may result from the interpolation of images when the coding has used this same interpolation to improve the precision of prediction.

At the end of the decoding of all the blocks of the current image, the same deblocking filter 207 as the one (115) provided at the encoder is used to eliminate the block effects so as to obtain the reference images 208.

The images thus decoded constitute the output video signal 209 of the decoder, which can then be displayed and used. This is why they are referred to as the “conventional” reconstructions of the images.

These decoding operations are similar to the decoding loop of the coder.

The inventors of the present invention have however found that the compression gains obtained by virtue of the multiple reference option remain limited. This limitation is rooted in the fact that a great majority (approximately 85%) of the predicted data are predicted from the image closest in time to the current image to be coded, generally the image that precedes it.

In this context, several improvements have been developed.

For example, in the publication “Rate-distortion constrained estimation of quantization offsets” (T. Wedi et al., April 2005), based on a rate-distortion constrained cost function, a reconstruction offset is determined to be added to each transformed block before being encoded. This tends to further improve video coding efficiency by directly modifying the blocks to encode.

On the other hand, the inventors of the present invention have sought to improve the image quality of the reconstructed closest-in-time image used as a reference image. This aims at obtaining better predictors, and then reducing the residual entropy of the image to encode. This improvement also applies to other images used as reference images.

More particularly, in addition to generating a first reconstruction of a first image (let's say the conventional reconstructed image), the inventors have further provided for generating a second reconstruction of the same first image, where the two generations comprise inverse quantizing the same transformed blocks with however respectively a first reconstruction offset and a second different reconstruction offset applied to the same block coefficient.

As explained above, the transformed blocks are generally quantized DCT block residues. As is known per se, the blocks composing an image comprise a plurality of coefficients each having a value. The manner in which the coefficients are scanned within the blocks, for example according to a zig-zag scan, defines a coefficient number for each block coefficient. In this respect, the expressions “block coefficient”, “coefficient index” and “coefficient number” will be used in the same way in the present application to indicate the position of a coefficient within a block according to the scan adopted.

For frequency-transformed blocks, there is usually a mean value coefficient (or zero-frequency coefficient) followed by a plurality of high frequency or “non-zero-frequency” coefficients.

On the other hand, “coefficient value” will be used to indicate the value taken by a given coefficient in a block.

In other words, the above improvements involve the invention having recourse to several different reconstructions of the same image in the video sequence, for example the image closest in time, so as to obtain several reference images.

The different reconstructions of the same image here differ concerning different reconstruction offset values used during the inverse quantization in the decoding loop.

Several parts of the same image to be coded can thus be predicted from several reconstructions of the same image which are used as reference images, as illustrated in FIG. 4.

At the encoding side, the motion estimation uses these different reconstructions to obtain better predictor blocks (i.e. closer to the blocks to encode) and therefore to substantially improve the motion compensation and the rate/distortion compression ratio. At the decoding side, they are correspondingly used during the motion compensation.

During the encoding process, data blocks of another image of the sequence are then encoded using motion compensation based on at least one reference image, said motion compensation selecting the reference image from a set of reference images comprising the two different first and second reconstructions.

In the application No FR 0957159 filed by the same applicant as the present invention and describing this novel approach for generating different reconstructions as reference images, there are described ways to select a second reconstruction offset value different from a first reconstruction offset (for example a so-called “conventional” reconstruction offset), and to select the corresponding block coefficient index to which the different reconstruction offset must be applied.

Based on the corresponding teachings, the inventors of the present application have considered a selection approach in which image reconstructions of the same first image are generated applying respectively, for the inverse quantization, each possible reconstruction offset and block coefficient pair. Then a rate/distortion encoding pass is performed considering successively each of these reconstructed images, to determine the most efficient pair of reconstruction parameters.

This approach is illustrated with reference to FIG. 9.

By virtue of the properties of the quantization and inverse quantization, the optimal reconstruction offset to choose belongs to the interval

$$[ - f ; f ] = [ - \vert \frac{q}{2} \vert ; \vert \frac{q}{2} \vert ] ,$$

where f is the quantization offset generally equal to q/2 (q being the quantizer used during the encoding of the first image).

In practical implementation, this interval depends on the quantization parameter QP used to encode the images, which size may range from 0 to 51. In this respect, the quantizer q is closely related to QP: for example, a decrease of 6 of QP corresponds to dividing q by two.

A first processing loop (steps 901 and 906) makes it possible to successively consider each coefficient of the transformed blocks.

A second processing loop (steps 902 and 905, nested in the first loop) makes it possible, for each considered block coefficient, to successively consider each possible reconstruction offset from the above interval.

At step 903, an image reconstruction of the first image is generated using the considered block coefficient and reconstruction offset of the current first and second loops when inverse quantizing the transformed blocks.

At step 904, a rate/distortion encoding pass is performed to evaluate the encoding cost of each pair of reconstruction offset and block coefficient. During the encoding pass, the current image to encode (i.e. an image other than the first image from which the reference images/reconstructions are built) is encoded using motion compensation with reference to the generated image reconstruction or any other reference image that is conventionally available.

After each rate/distortion cost has been calculated for each pair of reconstruction offset and block coefficient, the pair having the best cost (e.g. the minimum value of a weighted sum of distortion measures) is selected to generate the second reconstruction (step 907).

This approach to compute and select the second different reconstruction offset and the corresponding block coefficient has several drawbacks.

Firstly, by exhaustively considering each pair of possible reconstruction offset and block coefficient, the computation and selection operation is very long, and technically unrealistic for encoders having low processing resources.

Secondly, the encoding pass that is implemented for each coefficient index and reconstruction offset pair is a demanding operation for the encoder.

More generally, the above selection process has therefore a high computational complexity that requires to be optimized.

There is also known the weighted prediction offset (WPO) approach introduced in the H.264/AVC standard. The WPO scheme seeks to compensate the difference in illumination between two images, for example in case of illumination changes such as fading transitions.

In the WPO scheme, a second reconstruction of a first image is obtained by adding a pixel offset to each pixel of the image, regardless of the position of the pixel. An encoding pass is then performed for each of both reconstructions (the conventional reconstruction and the second reconstruction) to determine the most efficient one that is kept for encoding the current image.

Considering the DCT-transformed image, the WPO approach has the same effect as adding the same reconstruction offset to the mean value block coefficient (or “DC coefficient”) of each DCT block, in the approach of FR 0957159. The reconstruction offset is for example computed by averaging the two images surrounding the first image.

The WPO approach is however not satisfactory. Firstly, this is because it requires encoding passes that are demanding in terms of processing. Secondly, an exhaustive selection of the possible reconstruction parameters is performed to determine the most efficient one.

The present invention seeks to overcome all or parts of the above drawbacks of the prior art. In particular, it aims to reduce the computational complexity of the reconstruction parameter selection, i.e. when selecting an efficient reconstruction offset and possibly a corresponding block coefficient.

It further seeks to achieve this aim while maintaining the coding efficiency.

### SUMMARY OF THE INVENTION

In this respect, the invention concerns in particular a method for encoding a video sequence of successive images made of data blocks, comprising:

generating first and second reconstructions from a quantized version of the same first image, where the two generations comprise inverse quantizing at least the same transformed block with respectively a first reconstruction offset and a second different reconstruction offset applied to the same block coefficient,

encoding data blocks of another image of the sequence using motion compensation based on at least one reference image, said motion compensation selecting the reference image from a set of reference images comprising the two different first and second reconstructions,

wherein generating the second reconstruction comprises:
selecting a first subset of reconstruction offsets from a larger set comprising possible reconstruction offsets;
generating image reconstructions of the first image by applying respectively each of the reconstruction offsets of the first subset to the same block coefficient of the at least one transformed block;
determining the reconstruction offset from the first subset that minimizes a distortion of the image reconstructions, so as to obtain a first optimum reconstruction offset;
determining a reconstruction offset external to the first subset based on the first optimum reconstruction offset, and then generating an image reconstruction of the first image by applying the external reconstruction offset to the same block coefficient of the at least one transformed block;
selecting, from amongst the first optimum reconstruction offset and the external reconstruction offset, the reconstruction offset that minimizes a distortion of the associated image reconstructions, so as to obtain a second optimum reconstruction offset to which the second different reconstruction offset used for generating the second reconstruction derives.

According to the invention, since the larger set of reconstruction offsets corresponds to all the possible offset values, selecting a subset reduces the search range for the reconstruction parameter selection. This contributes to significantly reducing the computational complexity of the reconstruction parameter selection, without impacting the coding efficiency as shown by the test results given below.

In addition, the possible reconstruction offset values of the subset are only used in combination with one block coefficient (the same block coefficient for all the reconstruction offset values) in the course of determining the second reconstruction offset. This contrasts with the above application FR 0957159 in which every possible offset value for every block coefficient is analyzed or looked at.

By avoiding such exhaustive processing of all reconstruction offsets and all block coefficients, the computational complexity of the method is significantly reduced to obtain an efficient reconstruction offset and a corresponding block coefficient.

Indeed, the results from tests as presented below show that the coding efficiency is substantially maintained, despite of the simplification of the reconstruction parameter (offset and block coefficient) selection process.

Furthermore, although an appropriate selection of the first subset may provide a good tradeoff between low complexity and stable coding efficiency (compared to the exhaustive scheme of FR 0957159), the selection of an external reconstruction offset may increase the likelihood of the coding efficiency remaining substantially the same, while not significantly increasing the computational complexity. This is particularly on account of the fact that this external reconstruction offset can be determined based on the first optimum reconstruction offset, given the particularities of the set of possible offset values and the way the first subset is constructed.

The selection of reconstruction parameters according to the invention is therefore faster than in the known techniques, thus reducing the time to encode a video sequence compared to the exhaustive method described above with reference to FR 0957159.

One may also note that the present invention as defined above may in one embodiment apply to the selection of the reconstruction offset for the DC coefficient in the WPO scheme.

In particular, selecting the first subset may advantageously comprise keeping only the negative reconstruction offsets from a larger subset of the set of possible reconstruction offsets. This is because, while the possible reconstruction offsets belong to the range

$$[ - \frac{q}{2} ; \frac{q}{2} ]$$

(where q is the quantizer used during the quantization of step 108), the inventors have observed that usually the mean value of an encoded image (using for example JM or KTA [for Key Technology Area]) is higher than the mean value of the original image (before encoding). Given this observation, the most efficient offset value will generally be a negative value to compensate for this observed higher mean value.

According to an embodiment of the invention, the determining of a reconstruction offset that minimizes a distortion of image reconstructions comprises computing, for each image reconstruction, a distortion measure involving the first image, the first reconstruction and the image reconstruction concerned.

It transpires from this embodiment that the selection of the reconstruction parameters is based on optimizing the reconstruction of the first image itself, rather than on optimizing the encoding of another image to encode. Simple distance functions may therefore be used, that are in general less demanding than a full encoding pass.

According to a particular feature, computing a distortion measure comprises computing a first distance between the image reconstruction concerned and the first image and computing a second distance between the same image reconstruction concerned and the first reconstruction.

Handling these two distances may simplify the determination of whether or not the considered image reconstruction is closer to the original image (the first image) than the first reconstruction (i.e. generally the conventional reference image).

In particular, computing a distortion measure further comprises determining the minimum distance between the first distance and the second distance.

According to another further particular feature, computing a distortion measure further comprises computing the first and second distances for each of a plurality of blocks dividing the first image, determining, for each block, the minimum distance between the first and second distances, and summing the determined minimum distances for all the blocks.

These provisions enable a new reconstruction (the second reconstruction) to be built that is closer to the first image than the first reconstruction, in order to maintain the coding efficiency while reducing the computational complexity thanks to the invention.

Furthermore, such an approach (distortion measures, summing, minimum function) proves to be much simpler to implement and to perform than a full encoding pass.

According to yet another particular feature, the distortion measures are independent of said other image to encode. This provision reflects the concept of finding the reconstruction that is closest to the first (original) image, instead of finding the reconstruction that best suits the coding of the current image to encode.

According to yet another embodiment of the invention, the block coefficient to which the reconstruction offsets of the first subset are applied is the mean value coefficient of the transformed blocks. This approach has appeared to be the most efficient way during tests performed by the inventors, possibly because the mean value coefficients are usually dominant compared to the high frequency coefficients.

According to a feature of the invention, the method further comprises, based on the second optimum reconstruction offset, determining a block coefficient amongst coefficients constituting the transformed blocks, so as to identify the block coefficient to which the second reconstruction offset is applied for generating the second reconstruction.

This provision enables only one reconstruction offset to be considered for the majority of the block coefficients. This ensures that low complexity is maintained while testing every block coefficient.

In particular, the determining of a block coefficient comprises:
for each of the high frequency block coefficients, generating an image reconstruction of the first image by applying the second optimum reconstruction offset to the high frequency block coefficient, and
selecting, from amongst the mean value block coefficient and the high frequency block coefficients, the block coefficient that minimizes a distortion of the associated image reconstructions, so as to obtain the block coefficient to which the second reconstruction offset is applied for generating the second reconstruction.

This provision enables each block coefficient to be taken into account with however a low additional complexity, contrary to the above application FR 0957159.

In particular, the determining of a block coefficient further comprises for each of the high frequency block coefficients, generating an image reconstruction of the first image by applying, to the high frequency block coefficient, the opposite value to the second optimum reconstruction offset, and

selecting the block coefficient selects, from amongst the mean value block coefficient and the high frequency block coefficients, the block coefficient that minimizes a distortion of the image reconstructions generated using the second optimum reconstruction offset and its opposite value.

This approach further increases the accuracy of the selected reconstruction parameters, with low additional processing costs.

Correspondingly, the invention concerns a device for encoding a video sequence of successive images made of data blocks, comprising:

generation means for generating first and second reconstructions from a quantized version of the same first image, where the two generations comprise inverse quantizing at least the same transformed block with respectively a first reconstruction offset and a second different reconstruction offset applied to the same block coefficient,

encoding means for encoding data blocks of another image of the sequence using motion compensation based on at least one reference image, said motion compensation selecting the reference image from a set of reference images comprising the two different first and second reconstructions,

wherein the generation means for generating the second reconstruction are configured to:
select a first subset of reconstruction offsets from a larger set comprising possible reconstruction offsets;
generate image reconstructions of the first image by applying respectively each of the reconstruction offsets of the first subset to the same block coefficient of the at least one transformed block;
determine the reconstruction offset from the first subset that minimizes a distortion of the image reconstructions, so as to obtain a first optimum reconstruction offset;
determine a reconstruction offset external to the first subset based on the first optimum reconstruction offset, and then generate an image reconstruction of the first image by applying the external reconstruction offset on the same block coefficient of the at least one transformed block;
select, from amongst the first optimum reconstruction offset and the external reconstruction offset, the reconstruction offset that minimizes a distortion of the associated image reconstructions, so as to obtain a second optimum reconstruction offset to which the second different reconstruction offset used for generating the second reconstruction derives.

The encoding device, or encoder, has advantages similar to those of the method disclosed above, in particular that of reducing the complexity of the encoding process while maintaining its efficiency.

Optionally, the encoding device can comprise means relating to the features of the method disclosed previously.

The invention also concerns an information storage means, possibly totally or partially removable, able to be read by a computer system, comprising instructions for a computer program adapted to implement an encoding method according to the invention when that program is loaded into and executed by the computer system.

The invention also concerns a computer program able to be read by a microprocessor, comprising portions of software code adapted to implement an encoding method according to the invention, when it is loaded into and executed by the microprocessor.

The information storage means and computer program have features and advantages similar to the methods that they use.

### BRIEF DESCRIPTION OF THE DRAWINGS

Other particularities and advantages of the invention will also emerge from the following description, illustrated by the accompanying drawings, in which:

FIG. 1 shows the general scheme of a video encoder of the prior art;

FIG. 2 shows the general scheme of a video decoder of the prior art;

FIG. 3 illustrates the principle of the motion compensation of a video coder according to the prior art;

FIG. 4 illustrates the principle of the motion compensation of a coder including, as reference images, multiple reconstructions of at least the same image;

FIG. 5 shows a first embodiment of a general scheme of a video encoder using a temporal prediction on the basis of several reference images resulting from several reconstructions of the same image;

FIG. 6 shows the general scheme of a video decoder according to the first embodiment of FIG. 5 enabling several reconstructions to be combined to generate an image to be displayed;

FIG. 7 shows a second embodiment of a general scheme of a video encoder using a temporal prediction on the basis of several reference images resulting from several reconstructions of the same image;

FIG. 8 shows the general scheme of a video decoder according to the second embodiment of FIG. 7 enabling several reconstructions to be combined to generate an image to be displayed;

FIG. 9 illustrates, in the form of a logic diagram, processing for obtaining reconstruction parameters according to an exhaustive selection method;

FIG. 10 illustrates, in the form of a logic diagram, an embodiment of the method according to the invention;

FIG. 11 is an array of test results showing the maintaining of the coding efficiency with the implementation of the invention; and

FIG. 12 shows a particular hardware configuration of a device able to implement one or more methods according to the invention.

### DETAILED DESCRIPTION OF EMBODIMENTS OF THE INVENTION

In the context of the invention, the coding of a video sequence of images comprises the generation of two or more different reconstructions of at least the same image based on which motion estimation and compensation is performed for encoding another image. In other words, the two or more different reconstructions, using different reconstruction parameters, provide two or more reference images for the motion compensation or “temporal prediction” of the other image.

The processing operations on the video sequence may be of a different nature, including in particular video compression algorithms. In particular the video sequence may be subjected to coding with a view to transmission or storage.

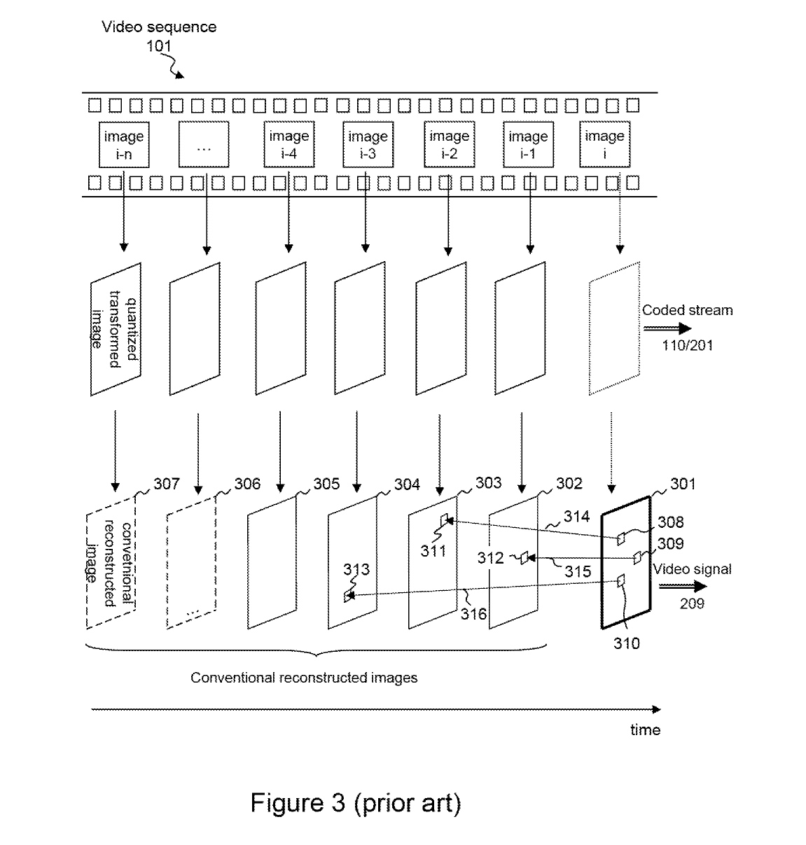

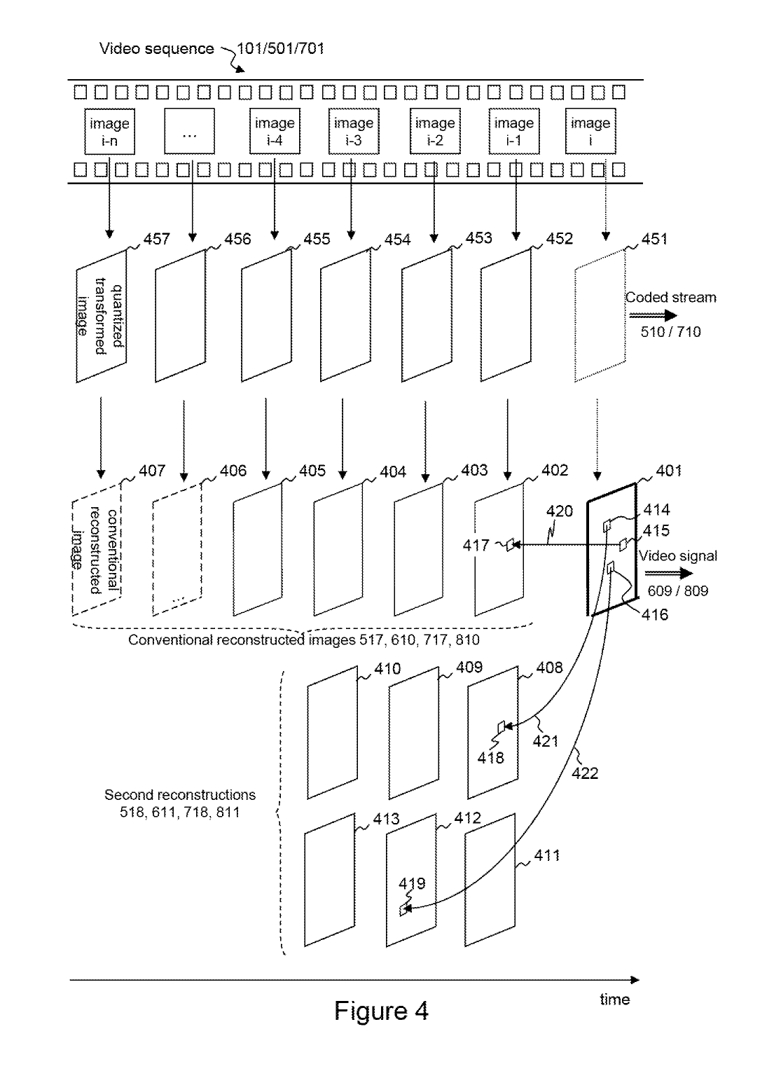

FIG. 4 illustrates motion compensation using several reconstructions of the same reference image as taught in the above referenced French application No 0957159, in a representation similar to that of FIG. 3.

The “conventional” reference images 402 to 405, that is to say those obtained according to the prior art, and the new reference images 408 to 413 generated through other reconstructions are shown on an axis perpendicular to the time axis (defining the video sequence 101) in order to show which reconstructions correspond to the same conventional reference image.

More precisely, the conventional reference images 402 to 405 are the images in the video sequence that were previously encoded and then decoded by the decoding loop: these images therefore correspond to those generally displayed by a decoder of the prior art (video signal 209) using conventional reconstruction parameters.

The images 408 and 411 result from other decodings of the image 452, also referred to as “second” reconstructions of the image 452. The “second” decodings or reconstructions mean decodings/reconstructions with reconstruction parameters different from those used for the conventional decoding/reconstruction (according to a standard coding format for example) designed to generate the decoded video signal 209.

As seen subsequently, these different reconstruction parameters may comprise a DCT block coefficient and a reconstruction offset θᵢ used together during an inverse quantization operation of the reconstruction (decoding loop).

As explained below, the present invention provides a method for selecting “second” reconstruction parameters (here the block coefficient and the reconstruction offset), when coding the video sequence 101.

Likewise, the images 409 and 412 result from second decodings of the image 453. Lastly, the images 410 and 413 result from second decodings of the image 454.

In the Figure, the block 414 of the current image 401 has, as its Inter predictor block, the block 418 of the reference image 408, which is a “second” reconstruction of the image 452. The block 415 of the current image 401 has, as its predictor block, the block 417 of the conventional reference image 402. Lastly, the block 416 has, as its predictor, the block 419 of the reference image 413, which is a “second” reconstruction of the image 453.

In general terms, the “second” reconstructions 408 to 413 of an image or of several conventional reference images 402 to 407 can be added to the list of reference images 116, 208, or even replace one or more of these conventional reference images.

It should be noted that, generally, it is more effective to replace the conventional reference images with “second” reconstructions, and to keep a limited number of new reference images (multiple reconstructions), rather than to routinely add these new images to the list. This is because a large number of reference images in the list increases the rate necessary for the coding of an index of these reference images (in order to indicate to the decoder which one to use).

However, a reference image that is generated using the “second” reconstruction parameters may be added to the conventional reference image to provide two reference images used to motion estimation and compensate for other images in the video sequence.

Likewise, it has been possible to observe that the use of multiple “second” reconstructions of the first reference image (the one that is the closest in time to the current image to be processed; generally the image that precedes it) is more effective than the use of multiple reconstructions of a reference image further away in time.

In order to identify the reference images used during encoding, the coder transmits, in addition to the total number and the reference number (or index) of reference images, a first indicator or flag to indicate whether the reference image associated with the reference number is a conventional reconstruction or a “second” reconstruction. If the reference image comes from a “second” reconstruction according to the invention, reconstruction parameters relating to this second reconstruction, such as the “block coefficient index” and the “reconstruction offset value” (described subsequently) are transmitted to the decoder, for each of the reference images used.

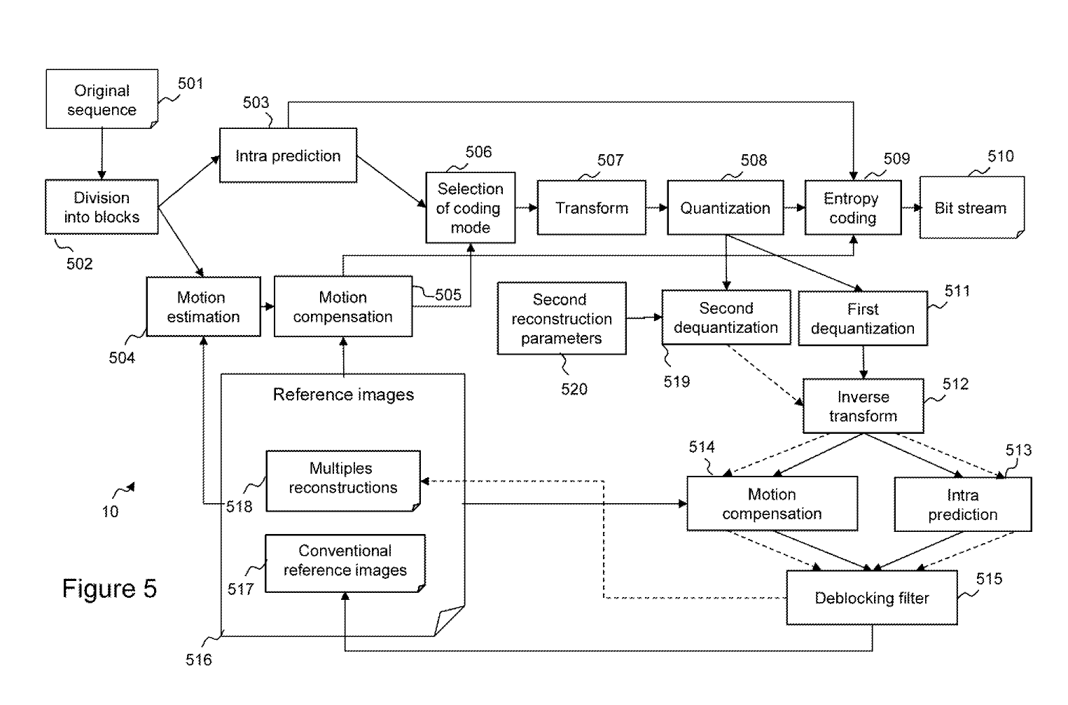

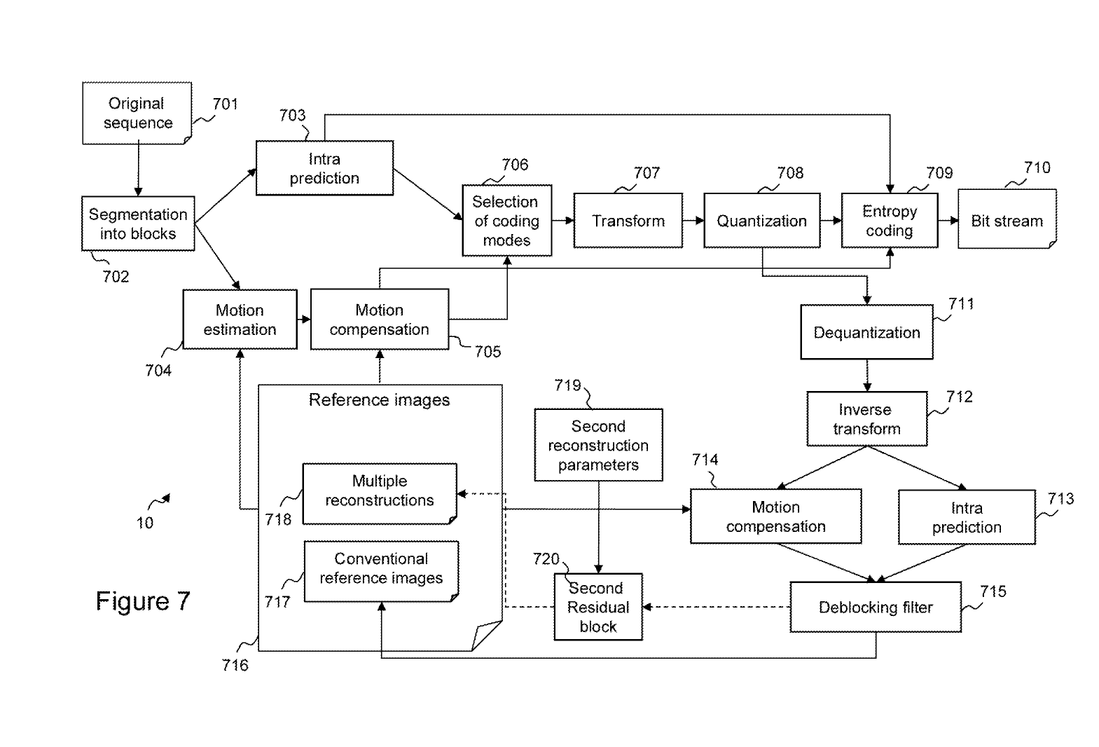

With reference to FIGS. 5 and 7, a description is now given of two alternative methods of coding a video sequence, using multiple reconstructions of a first image of the video sequence.

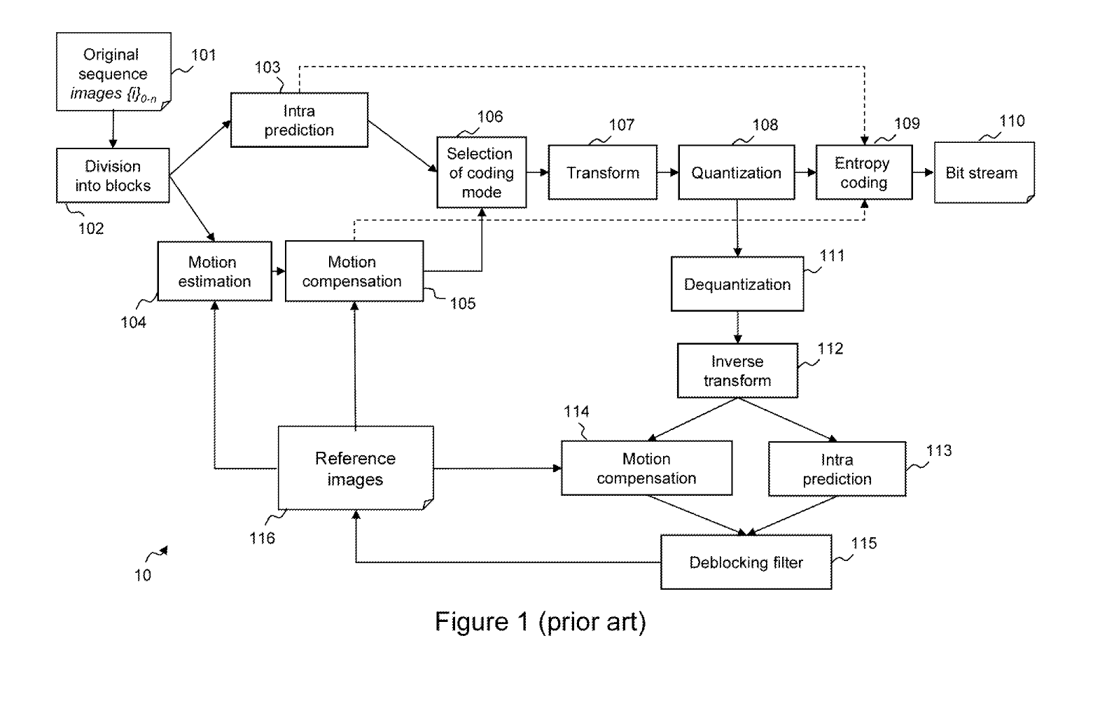

Regarding the first embodiment, a video encoder 10 comprises modules 501 to 515 for processing a video sequence with a decoding loop, similar to the modules 101 to 115 in FIG. 1.

In particular, according to the standard H.264, the quantization module 108/508 performs a quantization of the residue of a current pixel block obtained after transformation 107/507, for example of the DCT type. The quantization is applied to each of the N values of the coefficients of this residual block (as many coefficients as there are in the initial pixel block). Calculating a matrix of DCT coefficients and running through the coefficients within the matrix of DCT coefficients are concepts widely known to persons skilled in the art and will not be detailed further here. In particular, the way in which the coefficients are scanned within the blocks, for example a zigzag scan, defines a coefficient number for each block coefficient, for example a mean value coefficient DC and various coefficients of non-zero frequency ACᵢ.

Thus, if the value of the i^{th} coefficient of the residue of the current DCT transformed block is denoted Wᵢ (the DCT block having the size N×N [for example 4×4 or 8×8 pixels], with i varying from 0 to M−1 for a block containing M=N×N coefficients, for example W₀=DC and Wᵢ=ACᵢ), the quantized coefficient value Zᵢ is obtained by the following formula:

$${Z}_{i} = int ( \frac{\vert {W}_{i} \vert + {f}_{i}}{{q}_{i}} ) \cdot sgn ( {W}_{i} )$$

where qᵢ is the quantizer associated to the i^{th} coefficient whose value depends both on a quantization parameter denoted QP and the position (that is to say the number or index) of the coefficient value Wᵢ in the transformed block.

To be precise, the quantizer qᵢ comes from a matrix referred to as a quantization matrix of which each element (the values qᵢ) is predetermined. The elements are generally set so as to quantize the high frequencies more strongly.

Furthermore, the function int(x) supplies the integer part of the value x and the function sgn(x) gives the sign of the value x.

Lastly, fᵢ is a quantization offset which enables the quantization interval to be centered. If this offset is fixed, it is in general equal to qᵢ/2.

On finishing this step, the quantized residual blocks are obtained for each image, ready to be coded to generate the bitstream 510. In FIG. 4, these images bear the references 451 to 457.

The inverse quantization (or dequantization) process, represented by the module 111/511 in the decoding loop of the encoder 10, provides for the dequantized value W′ᵢ of the i^{th} coefficient to be obtained by the following formula:

W′ᵢ=(qᵢ·|Zᵢ|−θᵢ)·sgn(Zᵢ).

In this formula, Zᵢ is the quantized value of the i^{th} coefficient, calculated with the above quantization equation. θᵢ is the reconstruction offset that makes it possible to center the reconstruction interval. By nature, θᵢ must belong to the interval [−|fᵢ|;|fᵢ|], i.e. generally to the interval

$$[ - \vert \frac{{q}_{i}}{2} \vert ; \vert \frac{{q}_{i}}{2} \vert ] .$$

To be precise, there is a value of θᵢ belonging to this interval such that W′ᵢ=Wᵢ. This offset is generally set equal to zero (θᵢ=0, ∀i) for the conventional reconstruction (to be displayed as decoded video output).

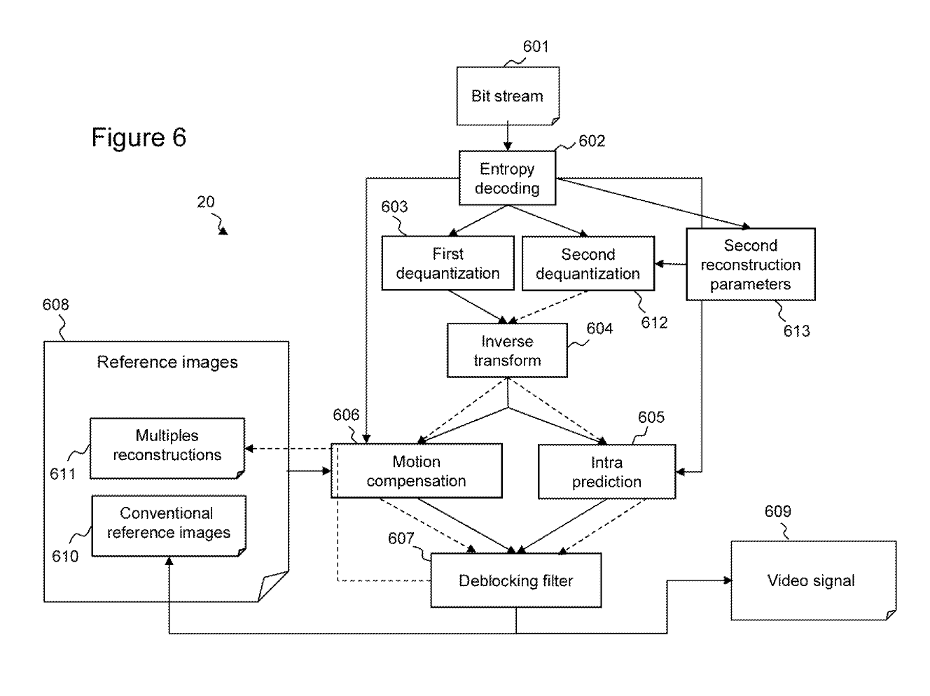

It should be noted that this formula is also applied by the decoder 20, at the dequantization 203 (603 as described below with reference to FIG. 6).

Still with reference to FIG. 5, the module 516 contains the reference images in the same way as the module 116 of FIG. 1, that is to say that the images contained in this module are used for the motion estimation 504, the motion compensation 505 on coding a block of pixels of the video sequence, and the motion compensation 514 in the decoding loop for generating the reference images.

The so-called “conventional” reference images 517 have been shown schematically, within the module 516, separately from the reference images 518 obtained by “second” decodings/reconstructions according to the invention.

In particular, the “second” reconstructions of an image are constructed within the decoding loop, as shown by the modules 519 and 520 enabling at least one “second” decoding by dequantization (519) by means of “second” reconstruction parameters (520).

Thus, for each of the blocks of the current image, two dequantization processes (inverse quantization) 511 and 519 are used: the conventional inverse quantization 511 for generating a first reconstruction (using θᵢ=0 for each DCT coefficient for example) and the different inverse quantization 519 for generating a “second” reconstruction of the block (and thus of the current image).

It should be noted that, in order to obtain multiple “second” reconstructions of the current reference image, a larger number of modules 519 and 520 may be provided in the encoder 10, each generating a different reconstruction with different reconstruction parameters as explained below. In particular, all the multiple reconstructions can be executed in parallel with the conventional reconstruction by the module 511.

Information on the number of multiple reconstructions and the associated reconstruction parameters are inserted in the coded stream 510 for the purpose of informing the decoder 20 of the values to use.

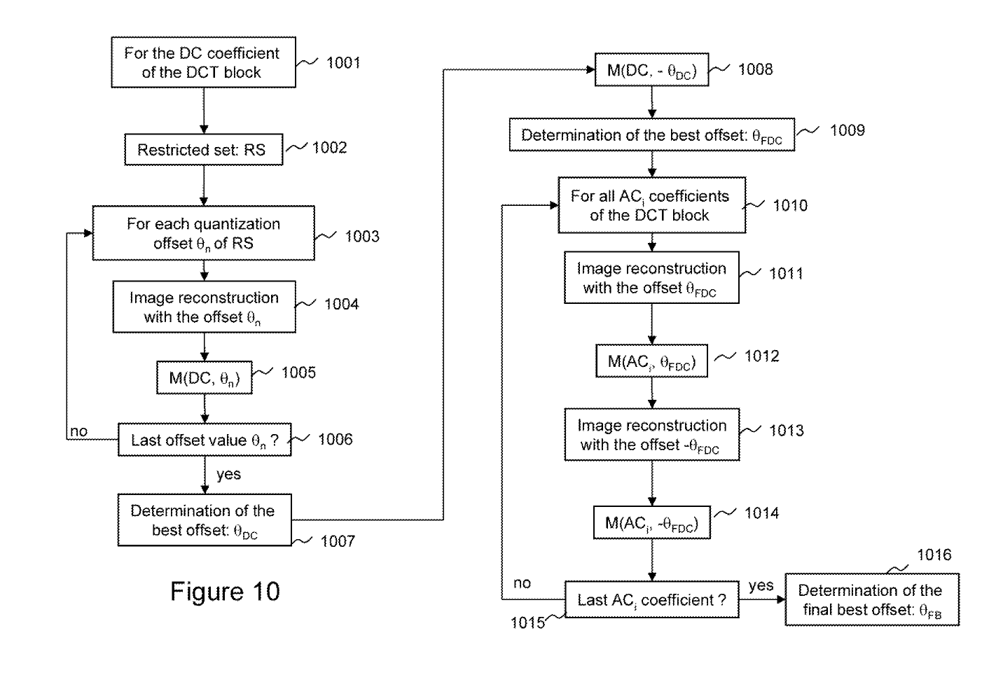

The module 519 receives the reconstruction parameters of a second reconstruction 520 different from the conventional reconstruction. The present invention details below with reference to FIG. 10, the operation of this module 520 to determine and select efficiently the reconstruction parameters for generating a second reconstruction. The reconstruction parameters received are for example a coefficient number i of the quantized transformed residue (e.g. DCT block) which will be reconstructed differently and the corresponding reconstruction offset θᵢ, as described elsewhere.

These reconstruction parameters may in particular be determined in advance and be the same for the entire reconstruction (that is to say for all the blocks of pixels) of the corresponding reference image. In this case, these reconstruction parameters are transmitted only once to the decoder for the image. However, it is possible to have parameters which vary from one block to another and to transmit those parameters (coefficient number and reconstruction offset θᵢ) block by block. Still other mechanisms will be referred to below.

These two reconstruction parameters generated by the module 520 are entropy encoded at module 509 then inserted into the binary stream (510).

In module 519, the inverse quantization for calculating W′ᵢ is applied using the reconstruction offset θᵢ, for the block coefficient i, as defined in the parameters 520. In an embodiment, for the other coefficients of the block, the inverse quantization is applied with the conventional reconstruction offset (generally θᵢ=0, used in module 511). Thus, in this example, the “second” reconstructions may differ from the conventional reconstruction by the use of a single different reconstruction parameter pair (coefficient, offset).

In particular, if the encoder uses several types of transform or several transform sizes, a coefficient number and a reconstruction offset may be transmitted to the decoder for each type or each size of transform.

As will be seen below, it is however possible to apply several reconstruction offsets θᵢ to several coefficients within the same block.

At the end of the second inverse quantization 519, the same processing operations as those applied to the “conventional” signal are performed. In detail, an inverse transformation 512 is applied to that new residue (which has thus been transformed 507, quantized 508, then dequantized 519). Next, depending on the coding of the current block (Intra or Inter), a motion compensation 514 or an Intra prediction 513 is performed.

Lastly, when all the blocks (414, 415, 416) of the current image have been decoded, this new reconstruction of the current image is filtered by the deblocking filter 515 before being inserted among the multiple “second” reconstructions 518.

Thus, in parallel, there are obtained the image decoded via the module 511 constituting the conventional reference image, and one or more “second” reconstructions of the image (via the module 519 and other similar modules the case arising) constituting other reference images corresponding to the same image of the video sequence.

In FIG. 5, the processing according to the invention of the residues transformed, quantized and dequantized by the second inverse quantization 519 is represented by the arrows in dashed lines between the modules 519, 512, 513, 514 and 515.

It will therefore be understood here that, like the illustration in FIG. 4, the coding of a following image may be carried out by block of pixels, with motion compensation with reference to any block from one of the reference images thus reconstructed, “conventional” or “second” reconstruction.

FIG. 7 illustrates a second embodiment of the encoder in which the “second” reconstructions are no longer produced from the quantized transformed residues by applying, for each of the reconstructions, all the steps of inverse quantization 519, inverse transformation 512, Inter/Intra determination 513-514 and then deblocking 515. These “second” reconstructions are produced more simply from the “conventional” reconstruction producing the conventional reference image 517. Thus the other reconstructions of an image are constructed outside the decoding loop.

In the encoder 10 of FIG. 7, the modules 701 to 715 are similar to the modules 101 to 115 in FIG. 1 and to the modules 501 and 515 in FIG. 5. These are modules for conventional processing according to the prior art.

The reference images 716 composed of the conventional reference images 717 and the “second” reconstructions 718 are respectively similar to the modules 516, 517, 518 of FIG. 5. In particular, the images 717 are the same as the images 517.

In this second embodiment, the multiple “second” reconstructions 718 of an image are calculated after the decoding loop, once the conventional reference image 717 corresponding to the current image has been reconstructed.

The “second reconstruction parameters” module 719 supplies for example a coefficient number i and a reconstruction offset Θᵢ to the module 720, referred to as the corrective residual module. A detailed description is given below with reference to FIG. 10, of the operation of this module 719 to determine and efficiently select the reconstruction parameters to generate a second reconstruction, in accordance with the invention. As for module 520, the two reconstruction parameters produced by the module 719 are entropy coded by the module 709, and then inserted in the bitstream (710).

The module 720 calculates an inverse quantization of a DCT block, the coefficients of which are all equal to zero (“zero block”), to obtain the corrective residual module.

During this dequantization, the coefficient in the zero block having the position “i” supplied by the module 719 is inverse quantized by the equation W′ᵢ=(qᵢ·|Zᵢ|−θᵢ)·sgn(Zᵢ) using the reconstruction offset θᵢ supplied by this same module 719 which is different from the offset (zero) used at 711. This inverse quantization results in a block of coefficients, in which the coefficient with the number i takes the value θᵢ, and the other block coefficients for their part remain equal to zero.

The generated block then undergoes an inverse transformation, which provides a corrective residual block.

Then the corrective residual block is added to each of the blocks of the conventionally reconstructed current image 717 in order to supply a new reference image, which is inserted in the module 718.

It will therefore be remarked that the module 720 produces a corrective residual block aimed at correcting the conventional reference image as “second” reference images as they should have been by application of the second reconstruction parameters used (at the module 719).

This method is less complex than the previous one firstly because it avoids performing the decoding loop (steps 711 to 715) for each of the “second” reconstructions and secondly since it suffices to calculate the corrective residual block only once at the module 720.

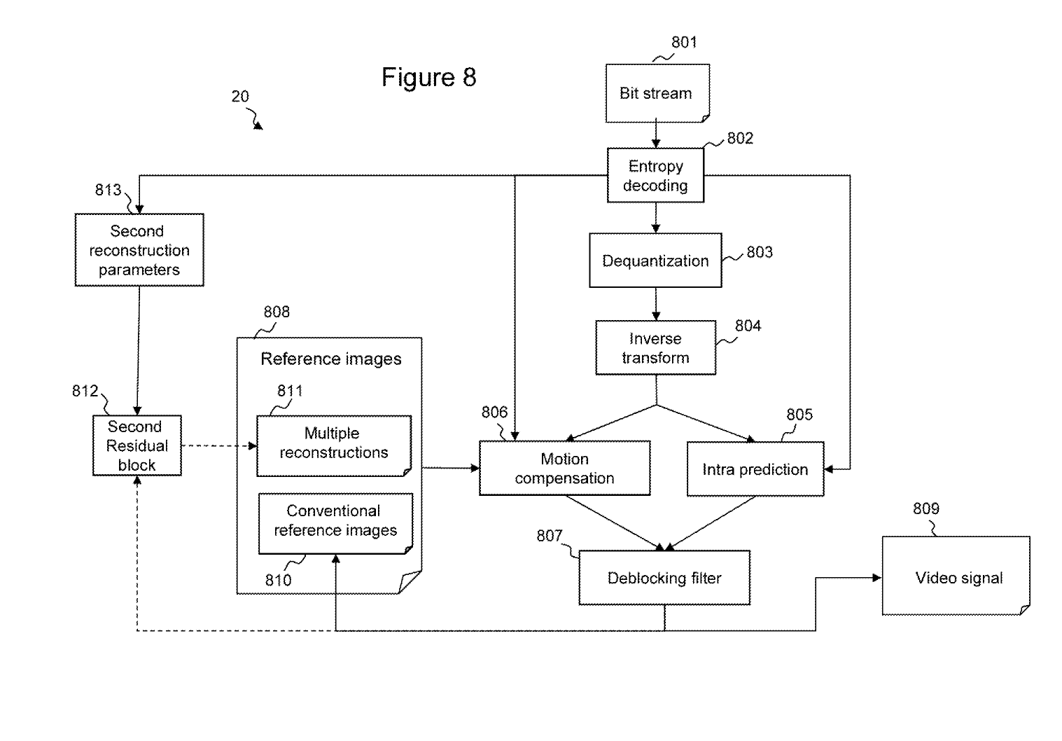

FIGS. 6 and 8 illustrate a decoder 20 corresponding to respectively the first embodiment of FIG. 5 and the second embodiment of FIG. 7.

As can be seen from these Figures, the decoding of a bit stream is similar to the decoding operations in the decoding loops of FIGS. 5 and 7, but with the retrieval of the reconstruction parameters from the bit stream 601, 801 itself.

With reference now to FIG. 10, a method is disclosed according to the invention for selecting a reconstruction offset and a block coefficient to generate a second reconstruction of a first image that will be used as a reference image for encoding other images of the video sequence.

This method improves the tradeoff between complexity and coding efficiency when using several different reconstructions of the first image as potential reference images. It may be implemented in numerous situations such as the encoding methods of FR 0957159 (see above FIGS. 5 and 7) and the WPO encoding method.

Below, a way to select one reconstruction offset and block coefficient pair is described (referred to as “reconstruction parameters”). However, one skilled in the art will have no difficulty to adapt the disclosed method in case it is intended to select more than one reconstruction offset and block coefficient pair. This is for example achieved by keeping the two or more best reconstruction offsets when, in the explanation below, only one best reconstruction offset is kept based on distortion measures.

In the exemplary embodiment below, only one block coefficient of the transformed blocks, for example the mean value coefficient DC, is first considered to determine an optimum reconstruction offset from a reduced set of possible reconstruction offsets. This determined reconstruction offset is then successively considered for each block coefficient, to determine an optimum block coefficient. Consequently, this embodiment avoids exhaustively considering each possible reconstruction offset and block coefficient pair.

Furthermore, the determination of the optimum reconstruction offset may comprise computing distortion measures involving the first image, the first reconstruction (possibly the conventional reconstruction) and each of the reconstructions built using successively each of the reconstruction offsets of the reduced set. It is therefore avoided to perform repetitively a full encoding pass to calculate a rate/distortion cost as disclosed above.

Other particular features are also implemented in this embodiment as described now with reference to FIG. 10. Let's consider an image of the video sequence, here below referred to as “first image”, from which a second reconstruction is built according to the invention.

At step 1001, the method starts by considering a DCT coefficient. Let's consider the mean value coefficient denoted DC.

At step 1002, the range

$$[ - \vert \frac{{q}_{i}}{2} \vert ; \vert \frac{{q}_{i}}{2} \vert ]$$

of possible reconstruction offsets is reduced to a restricted set S of reconstruction offsets, for example

$$\{ - \frac{q}{2} ; - \frac{q}{4} ; - \frac{q}{6} ; - \frac{q}{8} ; \frac{q}{8} ; \frac{q}{6} ; \frac{q}{4} ; \frac{q}{2} \} .$$

One may note that this set S excludes the conventional reconstruction offset θᵢ=0.

In particular, this set S may be further restricted to its negative values only:

$$\{ - \frac{q}{2} ; - \frac{q}{4} ; - \frac{q}{6} ; - \frac{q}{8} \} .$$

The obtained restricted subset is denoted RS.

The first restriction has the advantage of limiting the number of reconstruction offsets to successively consider.

The second restriction is based on an observation that the mean value of an encoded image (using for example JM or KTA) is usually higher than the corresponding mean value of the original image before encoding. This is mainly due to the rounding errors of the interpolation filters in the reference software of H.264/KTA. This has the advantage of providing a more limited number of reconstruction offsets to consider for determining the reconstruction parameters according to the invention.

A first processing loop (steps 1003 to 1006) makes it possible to successively consider each reconstruction offset θₙ of the restricted subset RS.

For a considered reconstruction offset θₙ, a reconstruction of the first image (step 1004) is first generated, in which the generation comprises inverse quantizing a transformed block by applying the reconstruction offset θₙ to the DC coefficient. The transformed block may be for example either the quantized transformed blocks of FIG. 5, or the transformed block with zero value used in module 720 of FIG. 7.

There is then computed (step 1005) a distortion error measure between this image reconstruction, the corresponding original first image (before encoding) and the corresponding conventional reconstruction (or any other reconstruction that may be used as a reference for this measure).

First, the distortion measure (which is not based on the coding of a current image to encode) appears to be much simpler to implement than a full encoding pass. Furthermore, such a measure makes it possible to determine an optimum reconstruction offset and block coefficient corresponding to a reconstruction that is closer to the original first image than the conventional reconstruction.

The distortion measure for the DC coefficient and the offset θₙ, denoted M(DC, θₙ), implements a block by block approach and sums measures computed for each transformed block of the images (DCT block with the size 4×4 or 8×8 pixels for example).

The measure for a block may implement computing of a first distance between the image reconstruction generated using the reconstruction offset θₙ applied on the DC coefficient (denoted Rec_{DC,θn}) and the first image (I) and computing a second distance between the same generated image reconstruction and the conventional reconstruction, denoted CRec.

For example the value M(DC, θₙ) may be as follows:

$$M ( D C , {θ}_{n} ) = {\sum }_{blocks of image I} min [ dist ( CRec , I ) , dist ( {Rec}_{D C , θ n} , I ) ]$$

where min[ ] is the minimum function, and dist( ) is a distance function such as SAD (sum of absolute differences), MAE (mean absolute error), MSE (mean square error) or any other distortion measure.

Given the formula, the lower the measure M(DC, θₙ), the closer the combination of added blocks of the reconstructions Rec_{DC,θn} and CRec is to the original first image.

When exiting the first loop 1003-1006, a measure M(DC, θₙ) has been computed for each reconstruction offset θₙ of the subset RS.

At step 1007, a first optimum reconstruction offset θ_{DC} is then determined. This is done by selecting the reconstruction offset θₙ of the subset RS, that corresponds to the minimal distortion measure M(DC, θ_{DC})=min [M(DC, θₙ)].

At step 1008, the opposite value −θ_{DC} to the first optimum reconstruction offset θ_{DC} may be considered to check whether or not this value is more appropriate in the course of generating a different reconstruction according to the invention. It is remarkable to note that, given the above construction of the restricted set RS, the opposite value −θ_{DC} is external to this set RS.

At this step 1008, calculation is made of the distortion measure M(DC, −θ_{DC}) corresponding to this opposite value −θ_{DC}.

At step 1009, the measures M(DC, θ_{DC}) and M(DC, −θ_{DC}) are compared to determine if the opposite value −θ_{DC} provides a lower distortion than the first optimum reconstruction offset θ_{DC}. The best offset from amongst θ_{DC} and −θ_{DC} is then selected as a second optimum reconstruction offset, denoted θ_{FDC}.

A second processing loop (steps 1010 to 1015) makes it possible to then consider each block coefficient (the AC coefficients in our example) to determine whether or not a lower distortion can be found when applying the second optimum reconstruction offset θ_{FDC} to any of the AC coefficients.

Compared to the method of FR 0957159, the second loop is outside the first loop in such a way that only one reconstruction offset is checked per each AC coefficient. This significantly reduces the amount of measure computations compared to considering each possible reconstruction offset and block coefficient pair.

At step 1010, a block coefficient, denoted ACᵢ, is selected for consideration.

At step 1011, a reconstruction Rec_{ACi,θFDC} of the first image is generated by applying the second optimum reconstruction offset θ_{FDC} to the considered ACᵢ coefficient when inverse quantizing a transformed block (either the quantized transformed blocks of FIG. 5, or the transformed block with zero value used in module 720 of FIG. 7).

At step 1012, the distortion measure M(ACᵢ, θ_{FDC}) is computed. At the optional steps 1013 and 1014, the opposite value −θ_{FDC} of the second optimum reconstruction offset θ_{FDC} is considered to check whether or not it provides a better (lower) distortion. During these steps, a reconstruction Rec_{ACi,-θFDC} is built (step 1013) and the corresponding distortion measure M(ACᵢ, −θ_{FDC}) is computed.

When exiting the second loop 1010-1015, two distortion measures have been computed for each AC coefficient, one with a reconstruction offset equal to θ_{FDC} and the other with the reconstruction offset equal to −θ_{FDC}. We also have the distortion measure for the DC coefficient using the second optimum reconstruction offset θ_{FDC}.

At step 1016, the minimal distortion measure amongst these measures is selected. The corresponding reconstruction offset (θ_{FDC} or −θ_{FDC}) and block coefficient (DC or ACᵢ) are therefore determined to be the pair of reconstruction parameters (reconstruction offset θ_{FB}, DCT block coefficient index i_{FB}) used to generate a second reconstruction according to the invention.

One may note that this method for selecting the reconstruction parameters may be implemented to determine the reconstruction offset to be applied to the DC coefficient in the WPO method. In this case, since the coefficient is fixed (DC coefficient), steps 1010 to 1014 may be avoided.

While the above example shows the selection of reconstruction parameters to generate one second reconstruction, several pairs of reconstruction parameters may be determined through implementation of the invention to generate several “second” reconstructions.

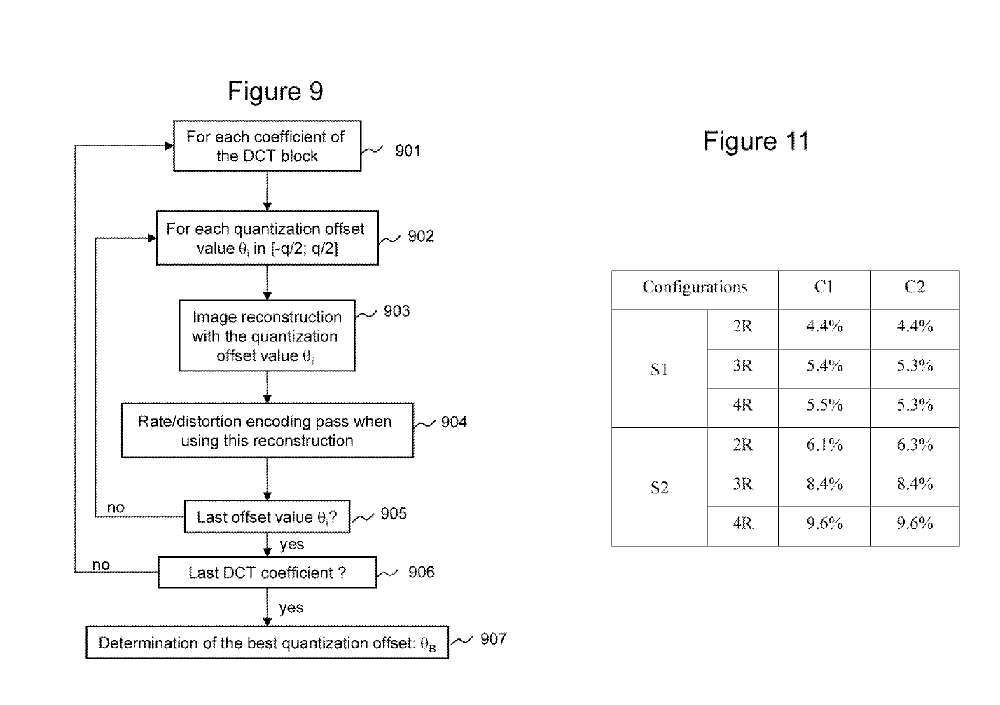

FIG. 11 gives results of tests to compare the method of FIG. 9 with the method of FIG. 10 according to the invention.

The table of the Figure draws the percentage of bitrate saving compared to conventional encoding according to H.264/AVC, for several configurations.

In a first set S1 of tests, the motion estimation of the image to encode is forced to be based on the second reconstruction from the exhaustive method of FIG. 3 (column C1) or from the method of the invention (column C2).

In a second set S2 of tests, the motion estimation of the image can be based on any of the second reconstruction, the conventional reconstruction or any other previous reference image. This implements an automatic selection (based on a bitrate/distortion criterion) from amongst these possible reference images.

For each set of tests, three configurations were examined. In the first one (2R), two second reconstructions from the same first image were built using the associated method (column C1 or C2). In the second one (3R), three second reconstructions were built. And in the third one (4R), four second reconstructions were built.

The table of the Figure shows that the same bitrate savings are obtained whatever the method used (C1 or C2). This is true for all the tests 2R, 3R, 4R and whatever the set of tests S1 or S2.

It may thus be concluded that the method according to the invention does not significantly modify the coding efficiency compared to the method of FR 0957159.

Furthermore, when using a quantization parameter QP equal to 33, 333 distinct values of the reconstruction offset were tested for column C1. In contrast, the implementation of the invention reduced this number to only 35 distinct values.

As a conclusion, the present invention, while maintaining the coding efficiency, significantly reduces the computational complexity of the reconstruction parameter selection.

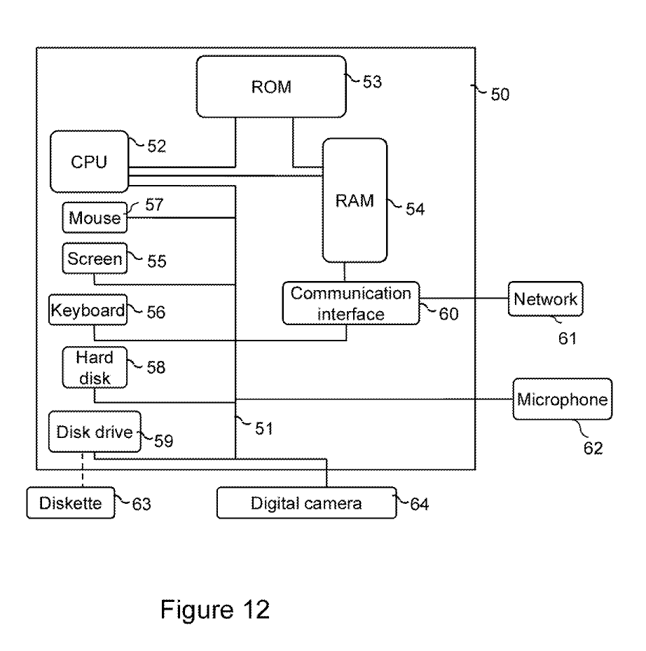

With reference now to FIG. 12, a particular hardware configuration of a device for coding a video sequence able to implement the method according to the invention is now described by way of example.

A device implementing the invention is for example a microcomputer 50, a workstation, a personal assistant, or a mobile telephone connected to various peripherals. According to yet another embodiment of the invention, the device is in the form of a photographic apparatus provided with a communication interface for allowing connection to a network.

The peripherals connected to the device comprise for example a digital camera 64, or a scanner or any other image acquisition or storage means, connected to an input/output card (not shown) and supplying to the device according to the invention multimedia data, for example of the video sequence type.

The device 50 comprises a communication bus 51 to which there are connected:
a central processing unit CPU 52 taking for example the form of a microprocessor;
a read only memory 53 in which may be contained the programs whose execution enables the methods according to the invention. It may be a flash memory or EEPROM;
a random access memory 54, which, after powering up of the device 50, contains the executable code of the programs of the invention necessary for the implementation of the invention. As this memory 54 is of random access type (RAM), it provides fast accesses compared to the read only memory 53. This RAM memory 54 stores in particular the various images and the various blocks of pixels as the processing is carried out (transform, quantization, storage of the reference images) on the video sequences;
a screen 55 for displaying data, in particular video and/or serving as a graphical interface with the user, who may thus interact with the programs according to the invention, using a keyboard 56 or any other means such as a pointing device, for example a mouse 57 or an optical stylus;
a hard disk 58 or a storage memory, such as a memory of compact flash type, able to contain the programs of the invention as well as data used or produced on implementation of the invention;
an optional diskette drive 59, or another reader for a removable data carrier, adapted to receive a diskette 63 and to read/write thereon data processed or to process in accordance with the invention; and
a communication interface 60 connected to the telecommunications network 61, the interface 60 being adapted to transmit and receive data.

In the case of audio data, the device 50 is preferably equipped with an input/output card (not shown) which is connected to a microphone 62.

The communication bus 51 permits communication and interoperability between the different elements included in the device 50 or connected to it. The representation of the bus 51 is non-limiting and, in particular, the central processing unit 52 unit may communicate instructions to any element of the device 50 directly or by means of another element of the device 50.

The diskettes 63 can be replaced by any information carrier such as a compact disc (CD-ROM) rewritable or not, a ZIP disk or a memory card. Generally, an information storage means, which can be read by a micro-computer or microprocessor, integrated or not into the device for processing a video sequence, and which may possibly be removable, is adapted to store one or more programs whose execution permits the implementation of the method according to the invention.

The executable code enabling the coding device to implement the invention may equally well be stored in read only memory 53, on the hard disk 58 or on a removable digital medium such as a diskette 63 as described earlier. According to a variant, the executable code of the programs is received by the intermediary of the telecommunications network 61, via the interface 60, to be stored in one of the storage means of the device 50 (such as the hard disk 58) before being executed.

The central processing unit 52 controls and directs the execution of the instructions or portions of software code of the program or programs of the invention, the instructions or portions of software code being stored in one of the aforementioned storage means. On powering up of the device 50, the program or programs which are stored in a non-volatile memory, for example the hard disk 58 or the read only memory 53, are transferred into the random-access memory 54, which then contains the executable code of the program or programs of the invention, as well as registers for storing the variables and parameters necessary for implementation of the invention.

It will also be noted that the device implementing the invention or incorporating it may be implemented in the form of a programmed apparatus. For example, such a device may then contain the code of the computer program(s) in a fixed form in an application specific integrated circuit (ASIC).

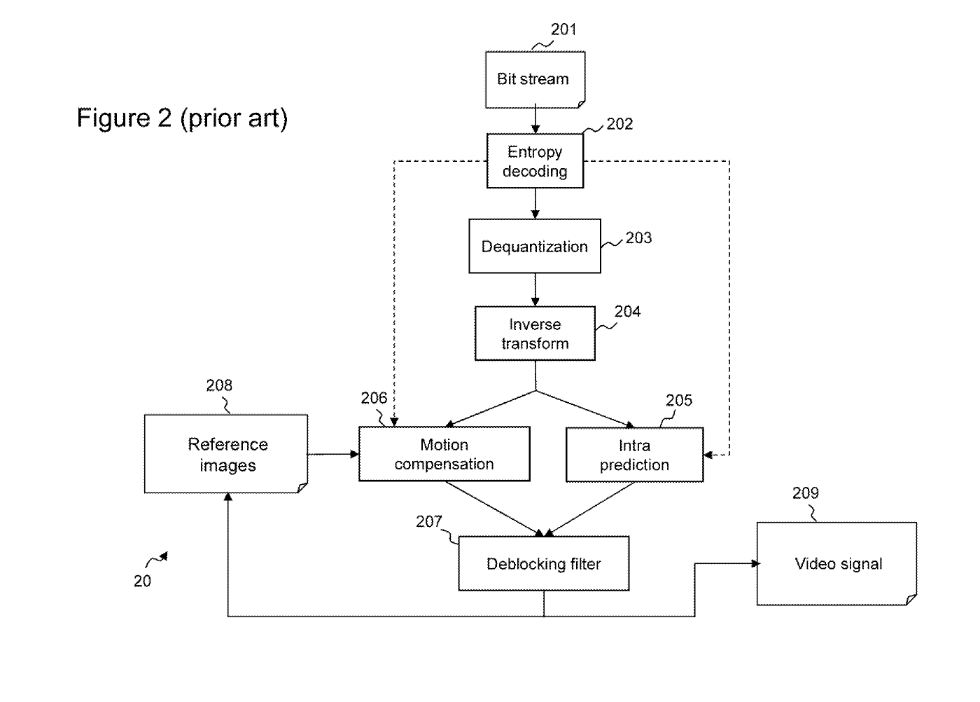

The device described here and, particularly, the central processing unit 52, may implement all or part of the processing operations described in relation with FIGS. 1 to 11, to implement the method of the present invention and constitute the device of the present invention.

The above examples are merely embodiments of the invention, which is not limited thereby.

In particular, mechanisms for interpolating the reference images can also be used during motion compensation and estimation operations, in order to improve the quality of the temporal prediction.

Such an interpolation may result from the mechanisms supported by the H.264 standard in order to obtain motion vectors with a precision of less than 1 pixel, for example ½ pixel, ¼ pixel or even ⅛ pixel according to the interpolation used.

According to another aspect, there is considered above the restricted set RS of negative reconstruction offsets only, and thus an external reconstruction offset for the step 1008 that is chosen as the opposite value of θ_{DC}.

However, other ways to restrict the set of possible reconstruction offsets may be applied, while an appropriate selection of an external reconstruction offset is therefore performed. For example, the restricted set RS may comprise the reconstruction offsets having the value 1/(2n), where n=±1, ±2, ±3, ±4 and ±5. In case the first optimum reconstruction offset is 1/2x, the chosen external value may be 1/(2x+1).

According to another aspect, while the above examples first consider the DC coefficient for steps 1001 to 1009, these steps may be conducted with any AC coefficient instead of the DC coefficient. In this case, the DC coefficient is considered when selecting the optimum coefficient through steps 1010 to 1015.

1. A method for encoding a video sequence of successive images made of data blocks, comprising:
generating first and second reconstructions from a quantized version of the same first image, where the two generations comprise inverse quantizing at least the same transformed block with respectively a first reconstruction offset and a second different reconstruction offset applied to the same block coefficient; and
encoding another image of the sequence using motion compensation based on at least one reference image, said motion compensation selecting the reference image from a set of reference images comprising the two different first and second reconstructions,
wherein generating the second reconstruction comprises:
selecting a first subset of reconstruction offsets from a larger set comprising possible reconstruction offsets;
generating image reconstructions of the first image by applying respectively each of the reconstruction offsets of the first subset to the same block coefficient of the at least one transformed block;
determining the reconstruction offset from the first subset that minimizes a distortion of the image reconstructions, so as to obtain a first optimum reconstruction offset;
determining a reconstruction offset external to the first subset based on the first optimum reconstruction offset, and then generating an image reconstruction of the first image by applying the external reconstruction offset to the same block coefficient of the at least one transformed block; and
selecting, from amongst the first optimum reconstruction offset and the external reconstruction offset, the reconstruction offset that minimizes a distortion of the associated image reconstructions, so as to obtain a second optimum reconstruction offset to which the second different reconstruction offset used for generating the second reconstruction derives.

2. The method of claim 1, wherein selecting the first subset comprises keeping only the negative reconstruction offsets from a larger subset of the set of possible reconstruction offsets.

3. The method of claim 1, wherein the determining of a reconstruction offset that minimizes a distortion of image reconstructions comprises computing, for each image reconstruction, a distortion measure involving the first image, the first reconstruction and the image reconstruction concerned.

4. The method of claim 3, wherein computing a distortion measure comprises computing a first distance between the image reconstruction concerned and the first image and computing a second distance between the same image reconstruction and the first reconstruction.

5. The method of claim 4, wherein computing a distortion measure further comprises determining the minimum distance between the first distance and the second distance.

6. The method of claim 1, wherein the distortion measures are independent of said other image to encode.

7. The method of claim 1, wherein the block coefficient to which the reconstruction offsets of the first subset are applied is the mean value coefficient of the transformed blocks.

8. The method of claim 7, wherein the mean value coefficient is the DC coefficient of DCT-transformed blocks.

9. The method of claim 1, wherein the determined reconstruction offset external to the first subset is the opposite value to the first optimum reconstruction offset.

10. The method of claim 1, wherein the first reconstruction offset has the value zero so that the first reconstruction is reconstructed from the first image with a reconstruction offset of zero.

11. The method of claim 1, further comprising, based on the second optimum reconstruction offset, determining a block coefficient amongst coefficients constituting the transformed blocks, so as to identify the block coefficient to which the second reconstruction offset is applied for generating the second reconstruction.

12. The method of claim 11, wherein the determining of a block coefficient comprises:
for each of the high frequency block coefficients, generating an image reconstruction of the first image by applying the second optimum reconstruction offset to the high frequency block coefficient, and
selecting, from amongst the mean value block coefficient and the high frequency block coefficients, the block coefficient that minimizes a distortion of the associated image reconstructions, so as to obtain the block coefficient to which the second reconstruction offset is applied for generating the second reconstruction.

13. The method of claim 12, wherein the determining of a block coefficient further comprises for each of the high frequency block coefficients, generating an image reconstruction of the first image by applying, to the high frequency block coefficient, the opposite value to the second optimum reconstruction offset, and
selecting, from amongst the mean value block coefficient and the high frequency block coefficients, the block coefficient that minimizes a distortion of the image reconstructions generated using the second optimum reconstruction offset and its opposite value.

14. A method for encoding a video sequence of successive images made of data blocks, comprising:
generating a first reconstruction from a quantized version of a first image, where the first generation comprises inverse quantizing at least one DCT-transformed block;
determining a weighted prediction offset;
generating a second reconstruction from the quantized version of the same first image, where the second generation comprises adding a weighted prediction offset added to the DC block coefficient of the at least one DCT-transformed block and inverse quantizing the resulting at least one DCT-transformed block having the weighted prediction offset added; and
encoding another image of the sequence using motion compensation based on at least one reference image, said motion compensation selecting the reference image from a set of reference images comprising the two different first and second reconstruction,
wherein determining the weighted prediction offset used to generate the second reconstruction comprises:
selecting a first subset of reconstruction offsets from a larger set comprising possible reconstruction offsets;
generating image reconstructions of the first image by adding respectively each of the reconstruction offsets of the first subset to the same DC block coefficient of the at least one DCT-transformed block and inverse quantizing the resulting DCT-transformed block;
determining the reconstruction offset from the first subset that minimizes a distortion of the image reconstructions, so as to obtain a first optimum reconstruction offset;
generating an image reconstruction of the first image by adding the opposite value to the obtained first optimum reconstruction offset to the same DC block coefficient of the at least one DCT-transformed block;
selecting, as said weighted prediction offset to be determined, the reconstruction offset amongst the first optimum reconstruction offset and its opposite value that minimizes a distortion of the associated image reconstructions.

15. The method of claim 14, wherein the same weighted prediction and reconstruction offsets are respectively applied to the DC block coefficient of all the DCT-transformed blocks of the first image.

16. A device for encoding a video sequence of successive images made of data blocks, comprising:
generation means for generating first and second reconstructions from a quantized version of the same first image, where the two generations comprise inverse quantizing at least the same transformed block with respectively a first reconstruction offset and a second different reconstruction offset applied to the same block coefficient,
encoding means for encoding data blocks of another image of the sequence using motion compensation based on at least one reference image, said motion compensation selecting the reference image from a set of reference images comprising the two different first and second reconstructions,
wherein the generation means for generating the second reconstruction are configured to:
select a first subset of reconstruction offsets from a larger set comprising possible reconstruction offsets;
generate image reconstructions of the first image by applying respectively each of the reconstruction offsets of the first subset to the same block coefficient of the at least one transformed block;
determine the reconstruction offset from the first subset that minimizes a distortion of the image reconstructions, so as to obtain a first optimum reconstruction offset;
determine a reconstruction offset external to the first subset based on the first optimum reconstruction offset, and then generate an image reconstruction of the first image by applying the external reconstruction offset to the same block coefficient of the at least one transformed block;
select, from amongst the first optimum reconstruction offset and the external reconstruction offset, the reconstruction offset that minimizes a distortion of the associated image reconstructions, so as to obtain a second optimum reconstruction offset to which the second different reconstruction offset used for generating the second reconstruction derives.

17. The device of claim 16, wherein the block coefficient to which the reconstruction offsets of the first subset are applied is the DC coefficient of DCT-transformed blocks.

18. The device of claim 16, wherein the determined reconstruction offset external to the first subset is the opposite value to the first optimum reconstruction offset.

19. The device of claim 16, wherein the first reconstruction offset has the value zero so that the first reconstruction is reconstructed from the first image with a reconstruction offset of zero.

20. A non-transitory computer-readable medium storing a program which, when executed by a microprocessor or computer system in an apparatus for encoding a video sequence of successive images made of data blocks, causes the apparatus to:
generate first and second reconstructions from a quantized version of the same first image, where the two generations comprise inverse quantizing at least the same transformed block with respectively a first reconstruction offset and a second different reconstruction offset applied to the same block coefficient and
encode another image of the sequence using motion compensation based on at least one reference image, said motion compensation selecting the reference image from a set of reference images comprising the two different first and second reconstructions,
wherein generating the second reconstruction causes the apparatus to:
select a first subset of reconstruction offsets from a larger set comprising possible reconstruction offsets;
generate image reconstructions of the first image by applying respectively each of the reconstruction offsets of the first subset to the same block coefficient of the at least one transformed block;
determine the reconstruction offset from the first subset that minimizes a distortion of the image reconstructions, so as to obtain a first optimum reconstruction offset;
determine a reconstruction offset external to the first subset based on the first optimum reconstruction offset, and then generate an image reconstruction of the first image by applying the external reconstruction offset to the same block coefficient of the at least one transformed block; and
select, from amongst the first optimum reconstruction offset and the external reconstruction offset, the reconstruction offset that minimizes a distortion of the associated image reconstructions, so as to obtain a second optimum reconstruction offset to which the second different reconstruction offset used for generating the second reconstruction derives.
